(19) United States
(12) Patent Application Publication
(10) Pub. No.: US 2004/0051630 A1
(43) Pub. Date: Mar. 18, 2004

(54) Vehicle with warning system

(76) Inventor: Robert K.G. Van de Moosdijk, Haarlem (NL)

Correspondence Address: ST. ONGE STEWARD JOHNSTON & REENS, LLC, 986 BEDFORD STREET, STAMFORD, CT, 06905-5619, US

(21) Appl. No.: 10/349,594

(22) Filed: Jan. 23, 2003

(30) Foreign Application Priority Data
Jan. 23, 2002 (NL) 1019818
Apr. 18, 2002 (NL) 1020422

(51) Int. Cl. B60Q 1/00

(52) U.S. Cl. 340/425.5

(57) ABSTRACT

The invention relates to a warning system in a vehicle, such as a truck or a bus. In a vehicle, on the side which is remote from a driver's position there are warning means which are activated when the direction indicator is switched on on this side. These warning means give other road users an additional warning which differs from the standard direction indicators.

The invention relates to a vehicle in accordance with the preamble of claim 1. A vehicle of this type is generally known. When the known vehicle is in use, the drivers are always exposed to the risk that they will fail to notice other road users when changing road or lane. This is because the vehicle is large and the driver is usually sitting high above the road. Another problem is that the vehicle is generally long and is sometimes provided with a trailer or semi-trailer, and consequently the sideways movement of the vehicle is greater and the area where there are road users who can have problems is extra wide. The risk of the driver failing to notice other road users exists primarily if these other road users are on the other side of the vehicle from the side where the driver's position is located and if these other road users are relatively difficult to spot, as is the case with pedestrians and cyclists. However, it is precisely this group of road users who tend to be on the other side of the vehicle, and this is also the most vulnerable group of road users.

To reduce the risk of accidents involving this vulnerable group of road users, on the known vehicles there are mirrors which enable the driver, in countries where traffic drives on the right and the driver's position is on the left-hand side of the vehicle, to observe the part of the road on the right-hand side next to the vehicle via the mirrors and to check whether there are other road users in that area. This solution has the drawback that mirrors of this type generally provide only a limited view of the section of road to the right of the vehicle, and consequently the driver cannot always anticipate the expected behaviour of road users present in that area. Another drawback is that at dusk or in the dark, only road users with lights are visible, and consequently stationary cyclists and pedestrians are often not spotted. Also, the mirrors quickly become dirty, making it more difficult to see the area, and the mirrors do not cover the area just in front of the right-hand side of the vehicle.

One of the measures used to reduce the risk of accidents is for the other road users to be warned in a known way when the vehicle is changing road or lane by means of flashing direction-indicator lamps which are also visible from the side of the vehicle. Direction-indicator lamps of this type are identical for both sides of the vehicle and for all traffic situations. The drawback of the known direction-indicator lamps is that in situations with increased risks they do not have any specific extra visibility, and consequently they do not give other road users sufficient warning.

To avoid the abovementioned drawbacks, the vehicle is designed in accordance with the characterizing clauses of claim 1. As a result of additional warning means being fitted only to that side of the vehicle which is less visible to the driver, they will be given extra attention by the road users, and will show the road users on that side the potential risk when they are activated, while other road users, such as oncoming traffic, will not be deterred by the warning means. The warning means may therefore be designed in such a manner that they emit a stronger signal.

According to an improvement, the device is designed in accordance with claim 2. In practice, it has been found that accidents when the vehicle is changing road or lane occur primarily if the vehicle is travelling at a low speed. This is probably because lorries tend to corner at low speed. If accidents happen when changing lane, this mainly occurs when they are moving out into a queue of traffic, which also takes place at a low speed. If the warning means are not switched on at higher speeds, other road users are not unnecessarily distracted in straightforward situations, for example when approaching an exit slip road.

According to a further improvement, the vehicle is designed in accordance with claim 3. This prevents the warning means from being activated when the alarm device is switched on, for example during loading and unloading.

According to a further improvement, the device is designed in accordance with claim 4. This makes the warning means a light signal which is noticeable even to those who are hard of hearing.

According to a further improvement, the device is designed in accordance with claim 5. This gives a clear signal to the surrounding area and also means that the driver will hear that the warning means have been activated.

According to a further improvement, the device is designed in accordance with claim 6. As a result, at night, when the light signal is in any case very visible indeed, the driver can switch off the acoustic signal, so that noise pollution is avoided.

According to a further improvement, the device is designed in accordance with claim 7. This prevents the acoustic signal from inadvertently being left switched off after the vehicle has been driven at night.

The invention also comprises a warning system according to the preamble of claim 8. Warning means of this type are customary in the transport field and are designed in such a manner that, during standard use, they do not cause any disturbance to other road users. The result of this is that they are not noticed or are insufficiently noticed by the average road user in situations where extra care is important. To avoid this drawback, the device is designed in accordance with the characterizing clause of claim 8. As a result, the warning means are activated when the vehicle is driving slowly, i.e. in situations when major changes in direction are to take place or when the situation is not straightforward. As a result of additional warning means being activated in precisely these situations when the direction of the vehicle is changing as described above, road safety is enhanced.

According to an improvement, the warning system is designed in accordance with claim 9. This prevents the warning means from being activated when the vehicle is stationary along the road and flashing lights on the vehicle, generally the direction-indicator lamps, are activated all around the vehicle in order to draw the attention of other traffic to this fact.

According to a further improvement, the warning system is designed in accordance with claim 10. As a result, the warning system can also be used at night without noise pollution affecting the surrounding area.

According to a further improvement, the warning system is designed in accordance with claim 11. This prevents the acoustic signal from inadvertently being left switched off after the vehicle has been driven at night.

The invention also comprises switching equipment according to claim 12. Accommodating the switching means in separate switching equipment means that they can easily be fitted into vehicles, with the result that the warning means and/or the warning system can easily be fitted in vehicles.

The invention is explained below with reference to a number of exemplary embodiments and with the aid of a drawing, in which:

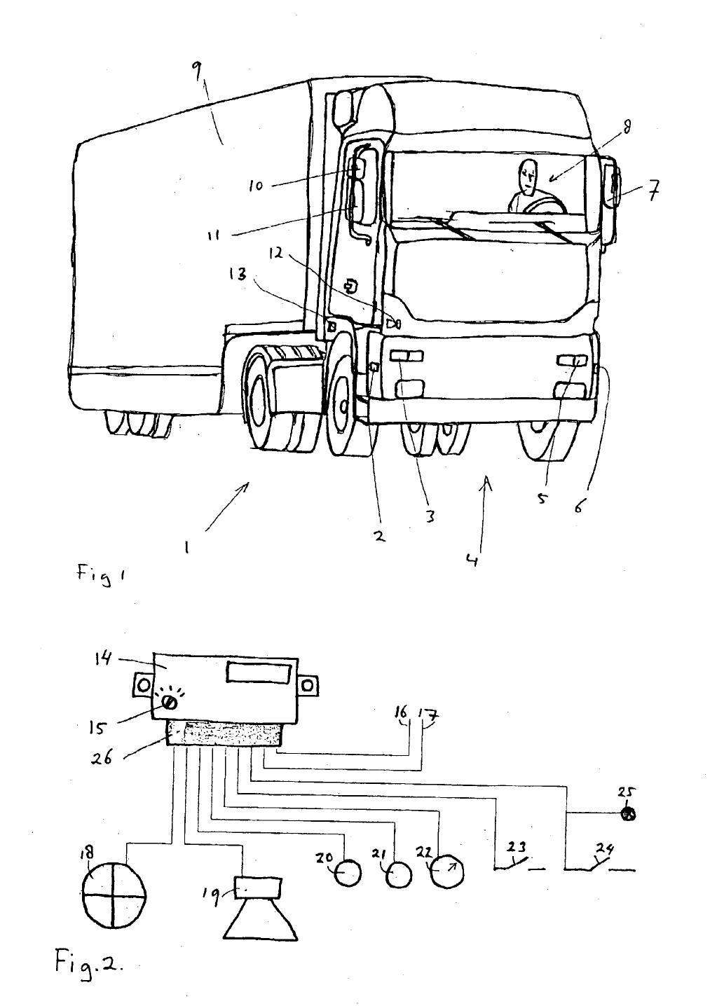

FIG. 1 shows a perspective view of a lorry equipped with a warning system, and

FIG. 2 shows a diagrammatic overview of the warning system shown in FIG. 1.

FIG. 1 shows a vehicle 1 which is composed of a lorry 4 to which a semi-trailer 9 is coupled. On the left-hand side, the lorry 4 is provided with a driver's position 8. When sitting in the driver's position 8, the driver can see the road on the left-hand side and behind the vehicle 1 via a left-hand wing mirror 7 and can see the road on the right-hand side and behind the vehicle 1 via a right-hand wing mirror 11. Since the wing mirrors 7 and 11 are positioned at a high level and also cover the road behind the vehicle 1, it is not possible to use these mirrors 7 and 11 to look at the road next to the lorry 4.

By looking to his left, the driver can view the road next to the lorry 4 on the left-hand side, and by using a mirror 10 he can view the road on the right-hand side of the lorry 4. Because the driver is sitting at a high level, it is difficult for him to see the area just in front of the lorry 4 and in particular the area to the right-hand side of and in front of the lorry 4 is difficult to see. In practice, it has been found that when using the two mirrors 10 and 11 it is not always possible to notice all road users who are situated to the right-hand side of and/or just in front of the vehicle 1.

To improve this situation, the lorry 4 may be designed in such a manner that the mirrors 10 and/or 11 can be adjusted into two positions, in which case in the first position of the mirrors 10 and/or 11 the driver can see the part of the road which is usual during normal driving, and in the second position of the mirrors 10 and/or 11 the driver can see that part of the road where there may be road users who may be impeded when the lorry 4 and semi-trailer 9 is changing road lane. In the process, the mirror 11 is rotated, for example, eight degrees outwards and a few degrees downwards. If appropriate, the position of mirror 10 is adjusted accordingly.

The lorry 4 is provided with an ignition lock which can be switched on by the driver and by means of which control of the lorry 4 is switched on. The lorry 4 and the semi-trailer 9 are provided in a known way with direction indicators which can be switched on using a switch. On the front side, the lorry 4 is provided with a right-hand direction indicator 3 and a left-hand direction indicator 5, and on the right-hand side the lorry is provided with a right-hand direction indicator 2, and on the left-hand side the lorry is provided with a left-hand direction indicator 6. Left and right direction indicators are also arranged at the back of the lorry 4 and at the back of the semi-trailer 9. The direction indicators are provided in a known way with means which cause the lamps to start to flash after they have switched on. Furthermore, the lorry 4 is provided with an alarm device which ensures that, after this device has been switched on, the direction-indicator lamps start to flash all the way around, in order to alert other road users to an exceptional situation, for example to be switched on when the vehicle is stationary on the road.

To warn the road users who are driving or walking on the right-hand side of the lorry 4 when the right-hand direction indicator 2 or 3 is activated, a stroboscopic lamp 13, which is switched on in a manner which is to be described below, is positioned at the side of the lorry 4. After it has been switched on, this stroboscopic lamp 13 continuously emits short, bright flashes of light which can be seen from the entire side of the vehicle 1, the lamp being most visible from in front of and at the front side of the vehicle 1. The stroboscopic lamp 13 is provided with means, such as a cover and/or shield, or designed in such a manner that other road users are not blinded by the bright light. If appropriate, a plurality of stroboscopic lamps 13 may be arranged along the right-hand side of the vehicle 1.

At the same time as the stroboscopic lamp 13, an acoustic horn 12 can be activated, this acoustic horn 12 being arranged behind cladding on the right-hand front side of the lorry 4. After it has been activated, the acoustic horn 12 emits a high-pitch, two-tone sound which road users on the right-hand side of the vehicle can easily recognize. The driver, who is seated at the driver's position 8, can also hear the noise of the acoustic horn 12, so that he knows that the stroboscopic lamp 13 is also switched on. If appropriate, a plurality of acoustic horns 12 may be positioned along the right-hand side of the vehicle 1. Other sound sources, such as a bell, may also be used instead of a horn.

At the same time as the stroboscopic lamp 13 being switched on, it is also possible for the position of the mirrors 10 and/or 11 to be adjusted, so that the driver has a better view of road users who may be impeded when the vehicle is changing lane or road.

FIG. 2 diagrammatically depicts switching equipment 14 and the connections by means of which the switching equipment 14 is connected to connections which are present in the lorry 4. In the exemplary embodiment shown, the switching equipment 14 is a separate unit, but it is also possible for the functions of this switching equipment 14 to be integrated in the control system which is present in the lorry 4.

The switching equipment 14 is connected to the control system and components of the lorry 4 via a plug connection 26. By means of a connection 16, the switching equipment 14 is connected to a power source, such as the 24-volt connection of a battery, and by means of a connection 17 the switching equipment 14 is connected to earth. Via a connection 20, the switching equipment 14 receives the signal that the left-hand direction indicator is switched on, and via a connection 21 the switching equipment 14 receives a signal that the right-hand direction indicator is switched on; if appropriate, these may be pulsed signals which match the flashing of the lamps of the direction indicators. If both connections 20 and 21 are activated simultaneously, the switching equipment 14 knows that the alarm device is switched on. In another embodiment, the alarm device may also emit a signal directly to the switching equipment 14 via the connection 20 after it has been switched on.

The lorry 4 is provided with a speedometer which, via a connection 22, emits a signal which is representative of the speed to the switching equipment 14. In the switching equipment 14, it is possible to detect whether the lorry 4 is travelling at a speed which is lower than a set value. This value can be set by means of an adjustment screw 15. By way of example, the adjustment screw 15 can be used to set a value between thirty and fifty kilometres per hour.

Via a connection 23, the switching equipment 14 receives a signal that the ignition lock has been switched on by the driver. This signal is used to switch the switching equipment 14 on and off. In the vicinity of the driver's position 8 there is a reset switch which emits a signal to the switching equipment 14 via a connection 24. This reset switch can be used to turn the acoustic horn 12 on or off. An indicator LED 25 is used to show whether or not the acoustic horn 12 is switched off. The driver will switch off the acoustic horn 12 if it is causing excessive noise pollution, for example at night. The standard setting is for the acoustic horn 12 to be switched on, and the switching equipment 14 is moved to the standard setting after the switching equipment 14 has been switched off and on using the ignition key.

The switching equipment 14 is programmed in such a manner that, if the speed of the lorry 4 is below the set value, when the right-hand direction indicator is activated, a connection 18 receives a signal, with the result that the stroboscopic lamp 13 is activated. When the alarm installation is activated, the stroboscopic lamp 13 is not activated. Also, a connection 19 will receive a signal, with the result that the acoustic horn 12 is activated. If appropriate, the driver can suppress activation of the acoustic horn 12 by actuating the reset switch. If the lorry 4 is provided with adjustable mirrors 10 and/or 11, they will adopt a different position when the stroboscopic lamp 13 is activated.

The exemplary embodiment has described a lorry 4 with a semi-trailer 9. It will be clear that the invention can also be used in a corresponding way for other vehicles in which the driver does not have a sufficiently clear view of other road users. Examples of other vehicles are buses, articulated lorries with trailers, lorry cabs, working vehicles, such as road sweepers, mobile cranes and delivery vans.

In the embodiment discussed, it has been assumed that the driver's position 8 is on the left-hand side of the vehicle 1. In that case, the driver has a less clear view of the area to the right-hand side of the vehicle, and consequently the stroboscopic lamp 13 and the acoustic horn 12 are arranged on that side. If the driver's position 8 is on the right-hand side of the vehicle 1, the stroboscopic lamp 13 and the acoustic horn 12 are, of course, arranged on the left-hand side.

1. Vehicle, such as a truck or a bus, provided, on a first side of the vehicle (1), with a driver's position (8) for a driver, and with a contact switch (23) for switching on the vehicle, a speedometer (22) for measuring the speed of the vehicle, and signalling means, which can be actuated by the driver, for indicating a change of lane or road, the signalling means comprising direction-indicator lamps (2, 3, 5, 6) and a first switch, which can be actuated by the driver, for switching on the direction-indicator lamps, characterized in that the vehicle comprises warning means (12, 13) which are arranged on a second side of the vehicle, along the side near to the front, and switching means (14), which are designed in such a manner that they activate the warning means when the direction-indicator lamps on the second side are switched on.

2. Vehicle according to claim 1, in which the switching means (14) are coupled to the speedometer (22) and are designed in such a manner that they only activate the warning means (12, 13) if the speed is lower than settable speed.

3. Vehicle according to claim 1 or 2, having an alarm device for simultaneously activating the direction-indicator lamps on both sides, the switching means being designed in such a manner that they only activate the warning means if the alarm device is not switched on.

4. Vehicle according to one of the preceding claims, in which the warning means comprise a lamp (13) for emitting a short, bright flashing light signal.

5. Vehicle according to one of the preceding claims, in which the warning means comprise means (12) for emitting an acoustic signal which if appropriate may be high-pitched and/or two-tone.

6. Vehicle according to claim 5, having a second switch (24), which can be actuated by the driver, connected to the switching means for blocking the acoustic signal.

7. Vehicle according to claim 6, in which the switching means are designed in such a manner that the blocking of the acoustic signal is eliminated by actuation of the contact switch (23).

8. Warning system for use in a vehicle, comprising warning means, such as a visual and/or acoustic signal, which warning means can be switched on automatically by switching means when direction-indicator lamps are activated, characterized in that the switching means are designed in such a manner that the warning means are only activated at a vehicle speed which is lower than a settable speed.

9. Warning system according to claim 8, in which the switching means are designed in such a manner that the warning means are only activated when the direction-indicator lamps on just one side of the vehicle are activated.

10. Warning system according to claim 8 or 9, in which the warning means comprise acoustic and visual signals, and the switching means are designed in such a manner that the acoustic signals can be switched off.

11. Warning system according to claim 10, in which the switching means are designed in such a manner that each time the vehicle is switched on again, the use of the acoustic signals is switched on.

12. Switching equipment having switching means for use in a vehicle or warning system according to one of the preceding claims.
